(19) United States
(12) Patent Application Publication
(10) Pub. No.: US 2003/0174588 A1
(43) Pub. Date: Sep. 18, 2003

(54) Electronic timepiece

(76) Inventor: Hiroyuki Masaki, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/378,722

(22) Filed: Mar. 4, 2003

(30) Foreign Application Priority Data
Mar. 13, 2002 (JP) 2002-068439

(51) Int. Cl. G04B 1/00; G04C 3/00

(52) U.S. Cl. 368/204

(57) ABSTRACT

In an electronic timepiece having a power saving mode, to prevent a situation in which a long period of time is needed for confirming a measured time period from being brought about. A mode control portion outputs a power saving processing signal to a display driving portion when an operating portion is not being operated for a predetermined time period in a state in which a chronograph measuring portion is not operated to measure a time period and a display driving portion erases display of a display portion to constitute a power saving mode. When the chronograph measuring portion carries out time measuring operation, the mode control portion prohibits the operation from being shifted to the power saving mode even when a nonoperational time period of the operating portion has elapsed the predetermined time period and therefore, a measured time period measured by the chronograph measuring portion is displayed at the display portion.

### BACKGROUND OF THE INVENTION

1. Field of the Invention

The present invention relates to an electronic timepiece having a time measuring function.

2. Description of the Prior Art

An electronic timepiece having a time measuring function (chronograph function) has conventionally been used.

The electronic timepiece includes a display portion for displaying a measured time or the like and a battery for driving respective constituent elements. A large amount of power is consumed in the display portion and when the display portion is always displayed, dissipation of the battery is accelerated and therefore, the display portion is constituted to shift to a power saving state in which display of the display portion is not carried out under a predetermined condition.

Thereby, the dissipation of the battery can be restrained and battery life can be extended.

However, according to the conventional electronic timepiece, only a time period during which an operating portion is not operated is specified as the condition of shifting to the power saving state. That is, when the operating portion is not operated continuously for a previously predetermined time period or more, the electronic timepiece is automatically shifted to the power saving state to erase display of the display portion.

In this case, even in operating the chronograph function, that is, measuring time, when a time period of not operating by the operating portion has elapsed the predetermined time period, the electronic timepiece is automatically shifted to the power saving mode to erase display of the display portion.

Therefore, when the measured time period is intended to confirm, it is necessary to temporarily release the power saving mode by operating the operating portion and thereafter display the measured time period by shifting to a measured time period display mode by operating the operating portion. That is, it is necessary to display current time by shifting to a time display mode constituting an initial display mode by operating to release the power saving mode and thereafter carry out operation of shifting to the measured time period display mode.

Therefore, according to the electronic timepiece having the power saving mode, there poses a problem of bringing about a situation in which a long period of time is needed until the measured time period can be confirmed.

### SUMMARY OF THE INVENTION

It is a problem of the invention to prevent the situation in which a long period time is needed for confirming the measured time period from being brought about in the electronic timepiece having the power saving mode.

According to the invention, there is provided an electronic timepiece characterized in that in an electronic timepiece including displaying means for displaying a measured time period and stopping display operation in response to a power saving processing signal, the electronic timepiece comprising operating means, time measuring means for operating to measure a time period, shift time period storing means for storing a predetermined shift time period, measuring operation determining means for determining whether the time measuring means is being operated to measure the time period and controlling means which does not output the power saving processing signal to the displaying means when the measuring operation determining means determines that the time measuring means is being operated to measure the time period and outputs the power saving processing signal to the displaying means when a nonoperational time period of the operating means has elapsed the shift time period in a case in which the measuring operation determining means determines that the time measuring means is not operated to measure the time period.

The controlling means does not output the power saving processing signal to the displaying means when the measuring operation determining means determines that the time period measuring means is being operated to measure the time period and outputs the power saving processing signal to the displaying means when the nonoperational time period of the operating means has elapsed the shift time period in the case in which the measuring operation determining means determines that the time period measuring means is not operated to measure the time period.

Here, the controlling means may be constituted to include nonoperational time period measuring means for counting the nonoperational time period of the operating means and display controlling means which does not output the power saving processing signal to the displaying means when the measuring operation determining means determines that the time period measuring means is being operated to measure the time period and outputs the power saving processing signal to the displaying means when the nonoperational time period measured by the nonoperational time period measuring means has elapsed the shift time period in a case in which the measuring operation determining means determines that the time period measuring means is not operated to measure the time period.

Further, according to the invention, there is provided an electronic timepiece characterized in that in an electronic timepiece including displaying means for displaying a measured time period and a power saving input mode for setting at least a power saving state and stopping display operation in response to a power saving processing signal outputted when the power saving state is set, the electronic timepiece comprising operating means, time period measuring means for operating to measure a time period, display mode instructing means for outputting a mode display signal for instructing to display at least the power saving input mode to the displaying means in accordance with an operation of the operating means, measuring operation determining means for determining whether the time measuring means is being operated to measure the time period, display mode controlling means for controlling the display mode instructing means such that a mode display signal for instructing to display the power saving input mode is not outputted when the measuring operation determining means determines that the time measuring means is being operated to measure the time period and controlling the display mode instructing means to be able to output the mode display signal for instructing to display the power saving input mode when the measuring operation determining means determines that the time period measuring means is not operated to measure the time period, and power saving controlling means for outputting the power saving processing signal to the displaying means after displaying the power saving input mode to the displaying means.

The display mode controlling means controls the display mode instructing means such that the mode display signal for instructing to display the power saving input mode is not outputted when the measuring operation determining means determines that the time period measuring means is being operated to measure the time period and controls the display mode instructing means to be able to output the mode display signal for instructing to display the power saving input mode when the measuring operation determining means determines that the time period measuring means is not operated to measure the time period. The power saving controlling means outputs the power saving processing signal to the display means after displaying the power saving input mode to the displaying means. In response to the power saving processing signal, the display means stops the display operation.

Here, the electronic timepiece may be constituted to include shift time period storing means for storing a predetermined shift time period, wherein the power saving controlling means outputs the power saving processing signal to the displaying means when a time period of displaying the power saving input mode has elapsed the shift time period.

Further, the electronic timepiece may be constituted such that the display mode instructing means successively outputs the display mode signal for instructing a plurality of display modes cyclically in response to the operation of the operating means and the displaying means carries out a display in correspondence with the display mode signal.

### BRIEF DESCRIPTION OF THE SEVERAL VIEWS OF THE DRAWINGS

A preferred form of the present invention is illustrated in the accompanying drawings in which:

FIG. 1 is a block diagram of an electronic timepiece according to an embodiment of the invention;

FIG. 2 is a flowchart showing processings of the electronic timepiece according to the embodiment of the invention;

FIG. 3 is a flowchart showing processings of the electronic timepiece according to the embodiment of the invention;

FIG. 4 is a display state transition diagram for explaining operation of the electronic timepiece according to the embodiment of the invention; and

FIG. 5 is a display state transition diagram for explaining operation of the electronic timepiece according to the embodiment of the invention.

### DETAILED DESCRIPTION OF THE PREFERRED EMBODIMENTS

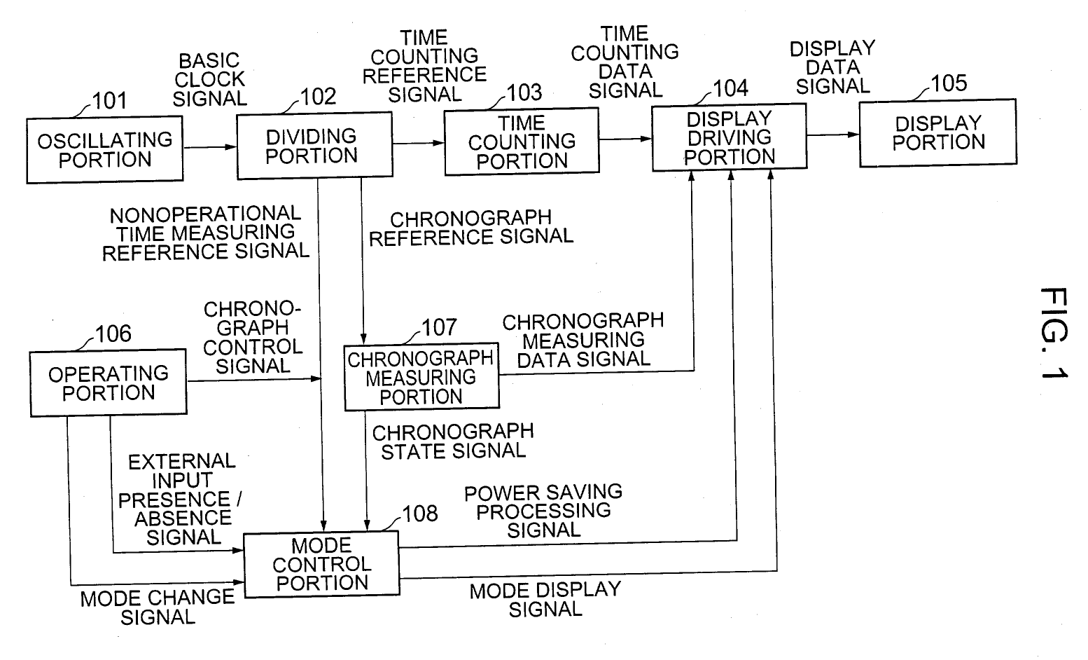

FIG. 1 is a functional block diagram of an electronic timepiece according to a mode for carrying out the invention showing an example of an electronic timepiece having a chronograph function.

In FIG. 1, the electronic timepiece is provided with an oscillating portion 101, a dividing portion 102, a time counting portion 103, a display driving portion 104, a display portion 105, an operating portion 106, a chronograph measuring portion 107 and a mode control portion 108.

The oscillating portion 101 generates a basic clock signal which is a signal for constituting a reference of respective operation. The dividing portion 102 divides the basic clock signal to generate a time counting reference signal which is a signal for constituting a reference of time counting operation, a chronograph reference signal which is a signal for measuring time in time measuring operation (chronograph operation), and a nonoperation time measuring reference signal which is a signal for measuring a time period during which the operating portion 106 is not operated continuously (nonoperation time period). The time counting portion 103 counts the time counting reference signal to generate a time counting data signal which is a signal indicating time.

The operating portion 106 is constituted by an operation button which can be operated by a user and by operating the operating portion 106, the operating portion outputs a chronograph control signal for starting measuring operation, an external input presence/absence signal which is a signal indicating whether the operating portion 106 is operated, and a mode change signal which is a signal for changing a display mode by the display portion 105.

The chronograph measuring portion 107 starts and stops time measuring operation in response to the chronograph control signal. The chronograph measuring portion 107 measures time by counting the chronograph reference signal in the time measuring operation and outputs a chronograph measuring data signal in correspondence with a measured time period and outputs a chronograph state signal indicating whether measuring is operated.

The mode control portion 108 includes a memory (not illustrated) for storing previously determined two kinds of predetermined time periods (first shift time period (5 seconds according to the embodiment) and second shift time period (1 hour according to the embodiment)). The mode control portion 108 outputs a mode display signal for instructing a mode displayed at the display portion 105 in response to the mode change signal to determine whether time measuring operation is being carried out based on the chronograph state signal. Further, when the mode control portion 108 determines that the time measuring operation is not being carried out (operation of not measuring time is being carried out), the mode control portion 108 outputs a power saving processing signal for instructing a power saving processing when operation of the operating portion 106 is not carried out during the shift time period based on the external input presence/absence signal. Further, the mode control portion 108 measures a time period of not operating the operating portion 106 by counting the nonoperation time measuring reference signal from the dividing portion 102.

The display driving portion 104 receives the time counting data signal, the chronograph measuring data signal, the power saving processing signal and the mode display signal and outputs a display data signal in accordance with the respective signals. For example, the display driving portion 104 outputs the display data signal of a mode in correspondence with the mode display signal, outputs the display data signal in correspondence with the time counting data signal when the mode display signal is a time display mode (TIME), outputs the display data signal in correspondence with the chronograph measuring data signal when the mode display signal is a chronograph display mode (CHRONO) and outputs the display data signal for erasing display when the power saving processing signal indicates a power saving processing.

The display portion 105 constituted by a liquid crystal digital display apparatus is operated to display in accordance with the display data signal, for example, display respective mode, display time and display measured time period and not to display by erasing display in power saving.

Further, the display driving portion 104 and the display portion 105 constitute displaying means, the operating portion 106 constitutes operating means, the chronograph measuring portion 107 constitutes time measuring means and the memory in the mode control portion 108 constitutes shift time period storing means. Further, the mode control portion 108 constitutes measuring operation determining means, controlling means, nonoperation time period measuring means, display controlling means, display mode indicating means, display mode controlling means and power saving controlling means.

According to the electronic timepiece constituted as described above, the mode change signal for changing the display mode is outputted to the mode control portion 108 by operating the operating portion 106. The display mode includes, for example, the time display mode (TIME) which is a display mode for displaying or setting current time, the measured time period display mode (CHRONO) which is a display mode for displaying a measured time period and carrying out a setting with regard to the measured time period, a data display mode (DATA) which is a display mode for selecting/displaying various data of past lap data stored to the memory in the mode control portion 108 and the like, a timer display mode (TIMER) which is a display mode for displaying or setting a timer, an alarm display mode (ALARM) which is a display mode for displaying or setting an alarm and a power saving input mode (POWER SAVE) which is a display mode for displaying and setting power saving setting.

Further, by operating the operating portion 106, the chronograph control signal for instructing to start or finish the time measuring operation is outputted to the chronograph measuring portion 107. When the operating portion 106 is operated, at each time of operation, the external input presence/absence signal indicating that the operating portion 106 is operated is outputted from the operating portion 106 to the mode control portion 108.

The dividing portion 102 divides the basic clock signal generated by the oscillating portion 101 to generate the time counting reference signal and outputs the time counting reference signal to the counting portion 103. The time counting portion 103 counts the time counting reference signal and outputs the time counting data signal indicating time to the display driving portion 104. When the mode control portion 108 outputs the mode display signal indicating time display in response to the mode change signal from the operating portion 106, the display driving portion 104 changes the time counting data signal to a mode suitable for display and outputs the display data signal indicating time to the display portion 105. The display portion 105 displays time in correspondence with the display digital signal in digital.

Meanwhile, the dividing portion 102 divides the basic clock signal from the oscillating portion 101 to output the chronograph reference signal which is the signal for measuring time in the time measuring operation (chronograph operation) to the chronograph measuring portion and outputs the nonoperation time measuring reference signal which is the signal for measuring the nonoperation time period of the operating portion 106 to the mode control portion 108.

When the time measuring operation is instructed to start by operating the operating portion 106, the chronograph control signal for instructing to start the time measuring operation is outputted from the operating portion 106 to the chronograph measuring portion 107. The chronograph measuring portion 107 starts the time measuring operation in response to the chronograph control signal and outputs the chronograph measuring data signal which is the signal in correspondence with the measured time period to the display driving portion 104. When the mode control portion 108 outputs the mode display signal indicating the time measuring display in response to the mode change signal from the operating portion 106, the display driving portion 104 changes the chronograph measuring data signal to a mode suitable for display and outputs the display data signal indicating the measured time period to the display portion 105. The display portion 105 displays the measured time period in correspondence with the display data signal in digital.

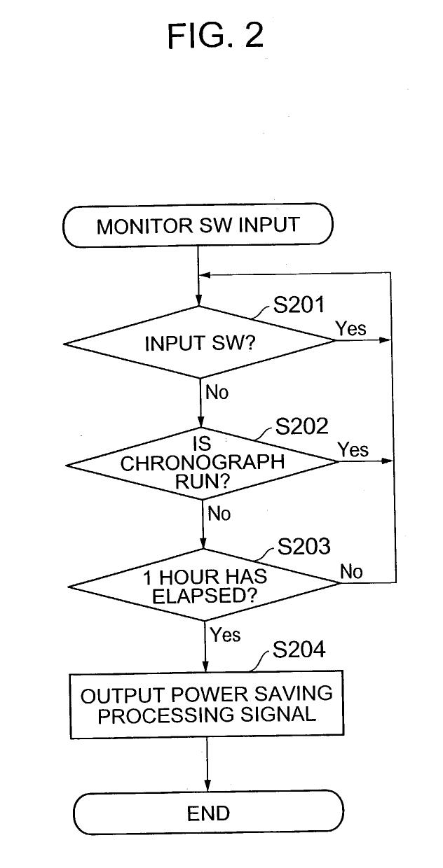

FIG. 2 is a flowchart showing processings according to the embodiment and is a diagram showing processings of automatically shifting to a power saving state when the operating portion 106 has not been operated continuously for a predetermined time period in a state in which time measuring operation is not carried out.

An explanation will be given of the processings of shifting to the power saving sate when the operating portion 106 has not been operated for a predetermined time period in reference to FIG. 1 and FIG. 2.

The mode control portion 108 monitors whether the operating portion 106 is operated by monitoring the external input presence/absence signal from the operating portion 106. It is determined whether the operating portion 106 is operated by monitoring whether an operation switch constituting the operating portion 106 is operated to input (step S201).

At step S201, when the mode control portion 108 determines that the operating portion 106 is not operated, it is determined whether a time measurement operational state is brought about (chronograph is run) by detecting the chronograph state signal from the chronograph measuring portion 107 (Step S202). Here, step S202 of processing the mode control portion 108 constitutes measuring operation determining means.

At step S202, when the mode control portion 108 determines that the time measurement operational state is not brought about, it is determined whether a nonoperational time period of the operating portion 106 has elapsed the second shift time period (1 hour) in reference to the memory in the mode control portion 108 (step S203). Here, step S203 of processing the mode control portion 108 constitutes nonoperational time period measuring means. Further, the mode control portion 108 measures the nonoperational time period by counting the nonoperation time measuring reference signal from the dividing portion 102.

When it is determined that the nonoperational time period has elapsed the second shift time period, the mode control portion 108 outputs the power saving processing signal to the display driving portion 104 (step S204). Here, step S204 of processing the mode control portion 108 constitutes display controlling means.

The display driving portion 104 outputs the display data signal for stopping display operation to the display portion 105. The display driving portion 104 controls the display portion 105 to erase display. Thereby, the operation shifts to the power saving mode to erase display of the display portion and power consumption is reduced.

When the operating portion 106 is operated in the power saving mode, the external input presence/absence signal indicating that the operating portion 106 is operated is outputted from the operating portion 106. The mode control portion 108 detects the external input presence/absence signal to thereby release the power saving mode and outputs the mode display signal for displaying the time display mode constituting the initial display mode to the display driving portion 104. The display driving portion 104 outputs the display data signal for displaying the time display mode to the display portion 105 and current time is displayed at the display portion 105.

Further, at steps S201 through S203, the operation returns to step S201 to repeat the processings respectively when the operating portion 106 is not operated, when time measurement is being operated and when the second shift time period has not elapsed.

As described above, the operation is made to shift to the power saving state when the operating portion 106 has not been operated continuously for the predetermined time period in a state in which the chronograph measuring portion 107 does not carry out the time measuring operation. Further, in a state in which the chronograph measuring portion 107 carries out the time measuring operation, the operation is not shifted to the power saving state even when the operating portion 106 has not been operated continuously for the predetermined time period. Therefore, even in the case in which the operating portion 106 has not been operated for the predetermined time period, when the time measuring operation is carried out, the operation does not shift to the power saving mode and therefore, the measured time period is displayed at the display portion 105 to thereby enable to confirm immediately.

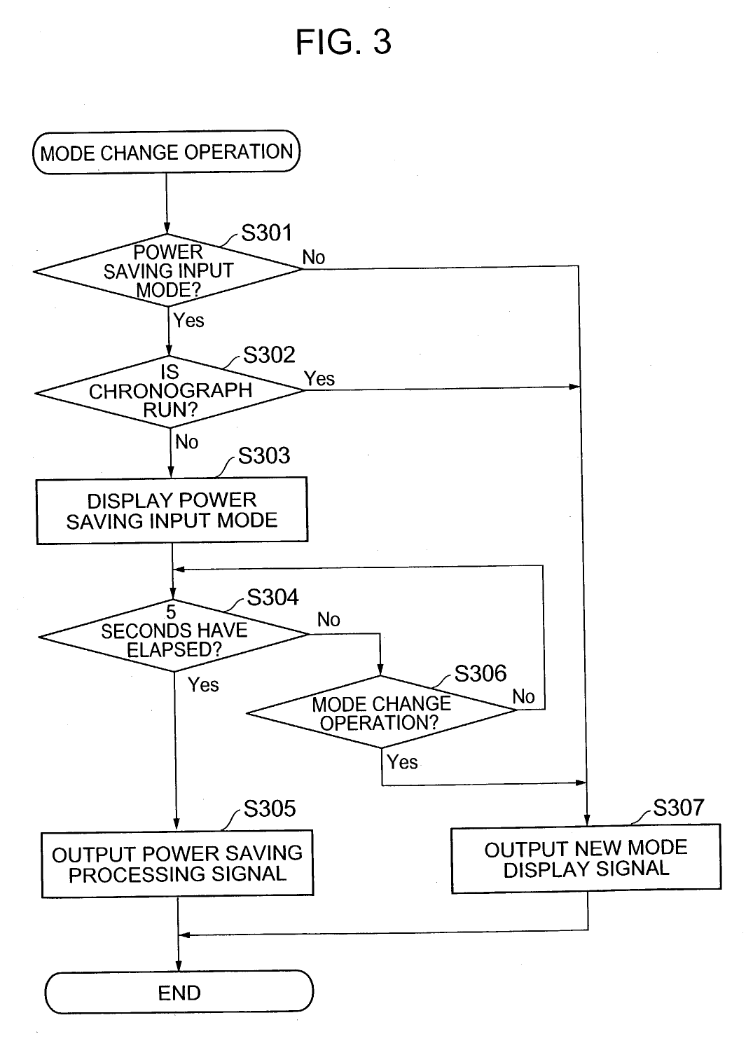

FIG. 3 is a flowchart showing processings according to the embodiment and is a diagram showing processings when the display mode is changed.

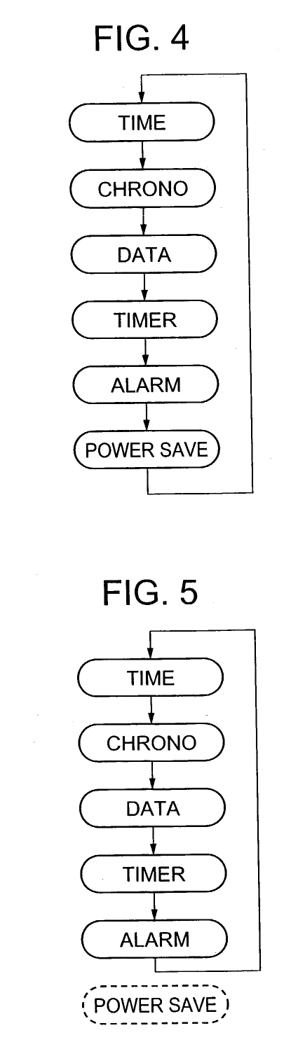

FIG. 4 and FIG. 5 are diagrams showing transition of the display mode according to the embodiment, FIG. 4 is a display mode transition diagram when the time measuring mode is not set and FIG. 5 is a display mode transition diagram when the time measuring mode is set.

An explanation will be given of processings when the display mode is changed in reference to FIG. 1, FIG. 3 through FIG. 5 as follows.

First, when the time measuring operation is not carried out, the mode change signal is outputted to the mode control portion 108 at each time of operating to change the display mode by the operating portion 106. In response to the mode change signal, the mode control portion 108 successively outputs the mode display signals indicating the time display mode (TIME), the measuring time display mode (CHRONO), the data display mode (DATA), the timer display mode (TIMER), the alarm display mode (ALARM) and the power saving input mode (POWER SAVE) cyclically in this order to the display driving portion 104. The display driving portion 104 outputs the display data signals in correspondence with the respective mode display signals, thereby, at each time of operating to change the display mode by the operating portion 106, as shown by FIG. 4, the display portion 105 is repeatedly displayed with the time display mode (TIME), the measuring time display mode (CHRONO), the data display mode (DATA), the timer display mode (TIMER), the alarm display mode (ALARM), and the power saving input mode (POWER SAVE) in this order.

Next, an explanation will be given of processings when the chronograph measuring portion 107 carries out the time measuring operation.

First, when the display mode is operated to change by operating the operating portion 106, the mode control portion 108 determines whether the power saving input mode is operated to change based on the mode change signal (step S301). At step S301, when the mode control portion 108 determines that the power saving input mode is not operated to change, a mode display signal indicating a display mode (new mode) successive to a current display mode is outputted to the display driving portion 104 (step S307). Thereby, the successive mode is displayed at the display portion 105.

At step S301, when the mode control portion 108 determines that the power saving input mode is operated to change, the mode control portion 108 determines whether the time measuring operational state is brought about (chronograph is run) (step S302). Here, step S302 of processing the mode control portion 108 constitutes measuring operation determining means.

At step S302, when the mode control portion 108 determines that the time measuring operational state is brought about, the operation does not shift to display the power saving input mode but shift to step S307, thereby, the display portion 105 is displayed with a new mode successively to a current mode similar to the above-described.

At step S302, when the mode control portion 108 determines that the time measuring operational state is not brought about, the mode control portion 108 outputs the mode display signal indicating the power saving input mode to the display driving portion 104 (step S303). Thereby, the display portion 105 is displayed with the power saving input mode. Further, steps S303 and S307 of processing the mode control portion 108 constitute display mode indicating means.

The mode control portion 108 determines whether the first shift time period (5 seconds according to the embodiment) stored to the memory in the mode control portion 108 has elapsed (step S304) in a state in which the power saving input mode is displayed at the display portion 105.

At step S304, when the mode control portion 108 determines that 5 seconds have not elapsed, the mode control portion 108 determines whether the operation of changing the mode is carried out by the operating portion 106 (step S306). At step S306, when the mode control portion 108 determines that the operation of changing the mode is not carried out by the operating portion 106, the operation returns to step S304 and when the mode control portion 108 determines that the operation of changing the mode is carried out by the operating portion 106, the operation proceeds to step S307. At step S307, as described above, the new mode (time display mode successive to power saving input mode) is displayed at the display portion 105.

Meanwhile, at step S304, when the mode control portion 108 determines that the operation of changing the mode has not been carried out for 5 seconds by the operating portion 106, the mode control portion 108 outputs the power saving processing signal to the display driving portion 104 (step S305). Thereby, the power saving mode state is brought about to stop display operation of the display portion 105 and display is erased.

Further, steps S304 and S305 for processing the mode control portion 108 constitute power saving controlling means.

By carrying out the above-described operation, as shown by FIG. 5, when the time measurement operational state is brought about, the power saving input mode is not displayed at the display portion 105 and therefore, setting to the power saving state is prohibited. Therefore, the display of the time measuring mode is not erased by shifting to the power saving state and therefore, the measured time period can swiftly be confirmed.

As described above, the electronic timepiece according to the embodiment is characterized in an electronic timepiece having displaying means for displaying a measured time period and stopping display operation in response to the power saving processing signal comrising the operating portion 106, the chronograph measuring portion 107 for operating to measure a time period, a memory for storing a predetermined shift time period, measuring operation determining means for determining whether the chronograph measuring portion 107 is being operated to measure the time period (mode control portion 108), and controlling means (mode control portion 108) which does not output the power saving processing signal to the displaying means (display driving portion 104, display portion 105) when the measuring operation determining means determines that the chronograph measuring portion 107 is being operated to measure the time period and outputs the power saving processing signal to the displaying means when a nonoperational time period of the operating portion 106 has elapsed the shift time period in a case in which the measuring operation determining means determines that the chronograph measuring portion 107 is not operated to measure the time period.

Here, the controlling means is characterized in including the nonoperational time period measuring means (mode control portion 108) for counting the nonoperational time period of the operating portion 106, and the display controlling means (mode control portion 108) which does not output the power saving processing signal to the displaying means when the measuring operation determining means determines that the chronograph measuring portion 107 is being operated to measure the time period and outputs the power saving processing signal to the displaying means when the nonoperational time period measured by the nonoperational time period measuring means has elapsed the shift time period in a case in which the measuring operation determining means determines that the chronograph measuring portion 107 is not operated to measure the time period.

Therefore, during the time measuring operation, even when the nonoperational time period of the operating portion 106 has elapsed the predetermined time period, the operation does not shift to the power saving mode and therefore, a situation in which a long period of time is needed for confirming the measured time period can be prevented from being brought about. Further, an effect that it is not necessary for the operating portion 106 to carry out operation of returning from the power saving mode or the like is achieved. Further, when the time period measuring operation is not carried out, in a case in which the nonoperational time period of the operating portion 106 has elapsed the predetermined time period, the operation shifts to the power saving state and therefore, power consumption can be reduced. Thereby, the battery life can be extended.

Further, the electronic timepiece according to the embodiment is characterized in an electronic timepiece having displaying means for displaying the measured time period and the power saving input mode for setting to at least the power saving state and stopping display operation in response to the power saving processing signal outputted when the power saving state is set, comprising the operating portion 106, the chronograph measuring portion 107 for carrying out the time measuring operation, display mode instructing means (mode control portion 108) for outputting the mode display signal for instructing to display at least the power saving input mode to the displaying means (display driving portion 104, display portion 105) in accordance with operation of the operating portion 106, the measuring operation determining means (mode control portion 108) for determining whether the chronograph measuring portion 107 is being operated to measure a time period, the display mode controlling means (mode control portion 108) for controlling the display mode instructing means such that the mode display signal for instructing to display the power saving input mode is not outputted when the measuring operation determining means determines that the chronograph measuring portion 107 is being operated to measure a time period and controlling the display mode instructing means to be able to output the mode display signal for instructing to display the power saving input mode when the measuring operation determining means determines that the chronograph measuring portion 107 is not operated to measure the time period, and the power saving controlling means (mode control portion 108) for outputting the power saving processing signal to the displaying means after displaying the power saving input mode to the displaying means.

Here, the power saving controlling means is characterized in including the memory for storing the predetermined shift time period and outputting the power saving processing signal to the displaying means when a time period of displaying the power saving input mode has elapsed the shift time period.

Further, the display mode instructing means is characterized in successively outputting the display mode signals for instructing a plurality of display modes cyclically in response to the operation of the operating portion 106 and the displaying means is characterized in carrying out displays in correspondence with the display mode signals.

Therefore, during the time period measuring operation, the power saving input mode is not displayed at the display portion 105 and therefore, the power saving mode cannot be set. Further, the power saving mode can be prevented from being set erroneously. Therefore, a situation in which a long period of time is needed for confirming the measured time period can be prevented from being brought about.

Further, when the time period measuring operation is not carried out, the power saving input mode is displayed at the display portion 105 and therefore, the power saving mode can be set and power consumption can be reduced. Thereby, the battery life can be extended.

Further, although according to the embodiment, the example of the chronograph is explained, the embodiment is applicable to various electronic timepieces having the time period measuring function of a stopwatch and the like.

According to the electronic timepiece of the invention, in the electronic timepiece having the power saving mode, the situation in which a long period of time is needed for confirming the measured time period can be prevented from being brought about.

What is claimed is

1. An electronic timepiece comprising:
operating means;
time measuring means for operating to measure a time period;
shift time period storing means for storing a predetermined shift time period;
measuring operation determining means for determining whether the time measuring means is being operated to measure the time period; and
controlling means which does not output the power saving processing signal to a displaying means when the measuring operation determining means determines that the time measuring means is being operated to measure the time period and outputs the power saving processing signal to the displaying means when a nonoperational time period of the operating means has elapsed the shift time period in a case in which the measuring operation determining means determines that the time measuring means is not operated to measure the time period.

2. The electronic timepiece according to claim 1,
wherein the controlling means includes nonoperational time period measuring means for counting the nonoperational time period of the operating means, and display controlling means which does not output the power saving processing signal to the displaying means when the measuring operation determining means determines that the time period measuring means is being operated to measure the time period and outputs the power saving processing signal to the displaying means when the nonoperational time period measured by the nonoperational time period measuring means has elapsed the shift time period in a case in which the measuring operation determining means determines that the time period measuring means is not operated to measure the time period.

3. An electronic timepiece comprising:
operating means;
time period measuring means for operating to measure a time period;
display mode instructing means for outputting a mode display signal for instructing to display at least the power saving input mode to the displaying means in accordance with an operation of the operating means;
measuring operation determining means for determining whether the time measuring means is being operated to measure the time period;
display mode controlling means for controlling the display mode instructing means such that a mode display signal for instructing to display the power saving input mode is not outputted when the measuring operation determining means determines that the time measuring means is being operated to measure the time period and controlling the display mode instructing means to be able to output the mode display signal for instructing to display the power saving input mode when the measuring operation determining means determines that the time period measuring means is not operated to measure the time period; and
power saving controlling means for outputting the power saving processing signal to the displaying means after displaying the power saving input mode to the displaying means.

4. The electronic timepiece according to claim 3, further comprising:
shift time period storing means for storing a predetermined shift time period;
wherein the power saving controlling means outputs the power saving processing signal to the displaying means when a time period of displaying the power saving input mode has elapsed the shift time period.

5. The electronic timepiece according to claim 3,
wherein the display mode instructing means successively outputs the display mode signal for instructing a plurality of display modes cyclically in response to the operation of the operating means and the displaying means carries out a display in correspondence with the display mode signal.

6. An electronic timepiece comprising:
a button;
a time measuring circuit for operating to measure a time period;
a shift time period storing circuit for storing a predetermined shift time period;
a measuring operation determining circuit for determining whether the time measuring circuit is being operated to measure the time period; and
a controller which does not output the power saving processing signal to a display the measuring operation determining circuit determines that the time measuring circuit is being operated to measure the time period and outputs the power saving processing signal to the display when a nonoperational time period of the operating circuit has elapsed the shift time period in a case in which the measuring operation determining circuit determines that the time measuring circuit is not operated to measure the time period.

7. An electronic timepiece comprising:
a button;
a time period measuring circuit for operating to measure a time period;
a display mode instructing circuit for outputting a mode display signal for instructing to display at least the power saving input mode to a displaying in accordance with an operation of the button;
a measuring operation determining circuit for determining whether the time measuring circuit is being operated to measure the time period;
a display mode controller for controlling the display mode instructing circuit such that a mode display signal for instructing to display the power saving input mode is not outputted when the measuring operation determining circuit determines that the time measuring circuit is being operated to measure the time period and controlling the display mode instructing means to be able to output the mode display signal for instructing to display the power saving input mode when the measuring operation determining circuit determines that the time period measuring circuit is not operated to measure the time period; and
a power saving controller for outputting the power saving processing signal to a display after displaying the power saving input mode to the display.
